(19) United States
(12) Patent Application Publication
(10) Pub. No.: US 2008/0118320 A1
(43) Pub. Date: May 22, 2008

(54) Chip cleaning device in NC processing machine

(76) Inventors: Takahiko Shozusawa, Aichi (JP); Junichi Kuriyama, Aichi (JP)

Correspondence Address: JACOBSON HOLMAN PLLC, 400 SEVENTH STREET N.W., SUITE 600, WASHINGTON, DC, 20004, US

(21) Appl. No.: 11/984,637

(22) Filed: Nov. 20, 2007

(30) Foreign Application Priority Data
Nov. 20, 2006 (JP) 2006-312761

(51) Int. Cl. B23Q 11/00

(52) U.S. Cl. 409/137

(57) ABSTRACT

There is provided an NC processing machine in which a cleaning operation is carried out automatically, instead of a processing operation. A turret having plural tool mounting surfaces at its outer peripheral surface is supported on a tool post which is movable in the directions of a Z axis and an X axis, such that the turret is rotatable about a T axis. A gripper shaft extending along an M axis parallel to the T axis and is spaced radially from the T axis is rotatably supported on one of the tool mounting surfaces of the turret. A movable gripper capable of detachably gripping a chip cleaning member is mounted to one end of the gripper shaft. A stationary gripper capable of detachably gripping the chip cleaning member is placed such that it can transfer and receive the chip cleaning member to and from the movable gripper within the range of movement caused by composite operations of the movement of the tool post in the directions of the Z axis and the X axis and the rotation of the turret about the T axis.

### BACKGROUND OF THE INVENTION

1. Field of the Invention

The present invention relates to a chip cleaning device in a machining tool, particularly in an NC processing machine having turning functions, such as an NC lathe and an NC compound lathe.

2. Description of the Related Art

Conventionally, among machining tools including automatic tool replacing devices, there have been known a machining tool structured such that tools required for processing are held by a main shaft and a chip cleaning member is housed in a tool magazine during normal work processing, but, when cleaning chips scattered around the main shaft, the tools are dismounted from the main shaft and housed in the tool magazine, the chip cleaning member is held by the main shaft instead of the tools, and the main shaft is caused to perform NC operations for performing cleaning (refer to, for example, Japanese Unexamined Utility Model Application Publication Nos. 56-121543 and 55-93437).

An NC processing machine having a turning function such as an NC lathe and an NC compound lathe is structured such that plural types of tools are held by a turret and, therefore, includes no automatic tool replacing device. Therefore, such an NC processing machine has not been able to cause, automatically, the main shaft to hold the chip cleaning member in the tool magazine instead of tools, and also to cause it to perform cleaning.

### SUMMARY OF THE INVENTION

It is an object of the present invention to provide a chip cleaning device capable of automatically performing cleaning operations, instead of processing operations, in an NC processing machine having a turning function, such as an NC lathe and an NC compound lathe.

A chip cleaning device according to a first aspect of the present invention is a chip cleaning device in an NC processing machine including a tool post movable in the direction of a Z axis and in the direction of an X axis and a tool mounting portion supported on the tool post such that it is rotatable about a T axis, the chip cleaning device including a chip cleaning member supported on the tool mounting portion and being adapted to clean a chip within a processing chamber through composite operations of the movement of the tool post in the direction of the Z axis and in the direction of the X axis and the rotation of the tool mounting portion about the T axis.

A chip cleaning device according to a second aspect of the present invention includes a rotational driving means for rotating a tool mounted on a tool mounting portion and is adapted to clean a chip within a processing chamber through composite operations of the movement of a tool post in the direction of a Z axis and in the direction of an X axis, the rotation of the tool mounting portion about a T axis, and the rotation of the tool.

In the chip cleaning device according to the first aspect of the present invention, the tool mounting portion may be a turret having a plurality of tool mounting surfaces at its outer peripheral surface, and the chip cleaning device preferably cleans a chip within the processing chamber through composite operations of the movement of the tool post in the direction of the Z axis and in the direction of the X axis and the rotation of the turret about the T axis.

The chip cleaning device according to the first aspect of the present invention may further include a driving means for rotating tools mounted to the tool mounting surfaces of the turret and may be adapted to clean a chip within the processing chamber through composite operations of the movement of the tool post in the direction of the Z axis and in the direction of the X axis, the rotation of the tool mounting portions about the T axis and the rotation of the tools.

The chip cleaning device according to the first aspect of the present invention may further include: a gripper shaft supported on one of the tool mounting surfaces of the turret; a movable gripper capable of detachably gripping the chip cleaning member, the movable gripper being mounted to one end of the gripper shaft; and a stationary gripper capable of detachably gripping the chip cleaning member, the stationary gripper being placed such that it can transfer and receive the chip cleaning member to and from the movable gripper within the range of movement caused by composite operations of the movement of the tool post in the direction of the Z axis and in the direction of the X axis and the rotation of the turret about the T axis.

In the chip cleaning device according to the first aspect of the present invention, the gripper shaft is preferably rotatably supported.

With the chip cleaning device according to the present invention, it is possible to enable the chip cleaning member to move over a maximum range and also to enable automatically cleaning of chips within the processing chamber in the machine, through composite operations the operations of the tool post along the X axis and the Z axis and the rotation of the tool mounting portion such as a turret on which the chip cleaning member is mounted. Here, in the case where the chip cleaning member is made rotatable, it is possible to enable the chip cleaning member to move over a further increased range, thereby further improving the ability to clean away chips within the processing chamber in the machine. When the tool mounting portion is a turret, the chip cleaning member can be constantly mounted to a surface of the turret, which enables rapid cleaning. In this case also, where the chip cleaning member is made movable, it is possible to perform cleaning efficiently. Further, by providing a gripper capable of holding and releasing the chip cleaning member and also storing the chip cleaning member at a position where the gripper can reach through the movement of the tool post along the X axis and the Z axis and the revolution of the turret, instead of mounting the chip cleaning member directly to a tool mounting surface of the turret, it is possible to mount the chip cleaning member rapidly, as required. Further, in this case, it is possible to dismount the chip cleaning member from the turret during processing, which can prevent the chip cleaning member from interfering with a workpiece and the inside of the processing chamber, during processing using other tools mounted on the turret. This can eliminate the necessity of giving consideration to such interfering, which enables provision of a chip cleaning member with a larger size for further expanding the cleaning range.

### BRIEF DESCRIPTION OF THE DRAWINGS

FIG. 1 is a side view of an entire NC processing machine including a chip cleaning device according to the present invention;

FIG. 2 is a rear view of the same;

FIG. 3 is a longitudinal and vertical sectional view illustrating mainly a tool post and a turret in the same NC processing machine along the line III-III in FIG. 2;

FIG. 4 is a cross-sectional view illustrating a portion of FIG. 3 in an enlarged manner;

FIG. 5 is a plan view of a movable gripper in a chip cleaning device and a cleaning tool gripped thereby;

FIG. 6 is a side view of a stationary gripper in the chip cleaning device;

FIG. 7 is a plan view of the same; and

FIG. 8 illustrates a locus of the tool post and the turret in the same NC processing machine during an NC operation.

### DETAILED DESCRIPTION OF THE PREFERRED EMBODIMENTS

Hereinafter, an embodiment of the present invention will be described with reference to the drawings.

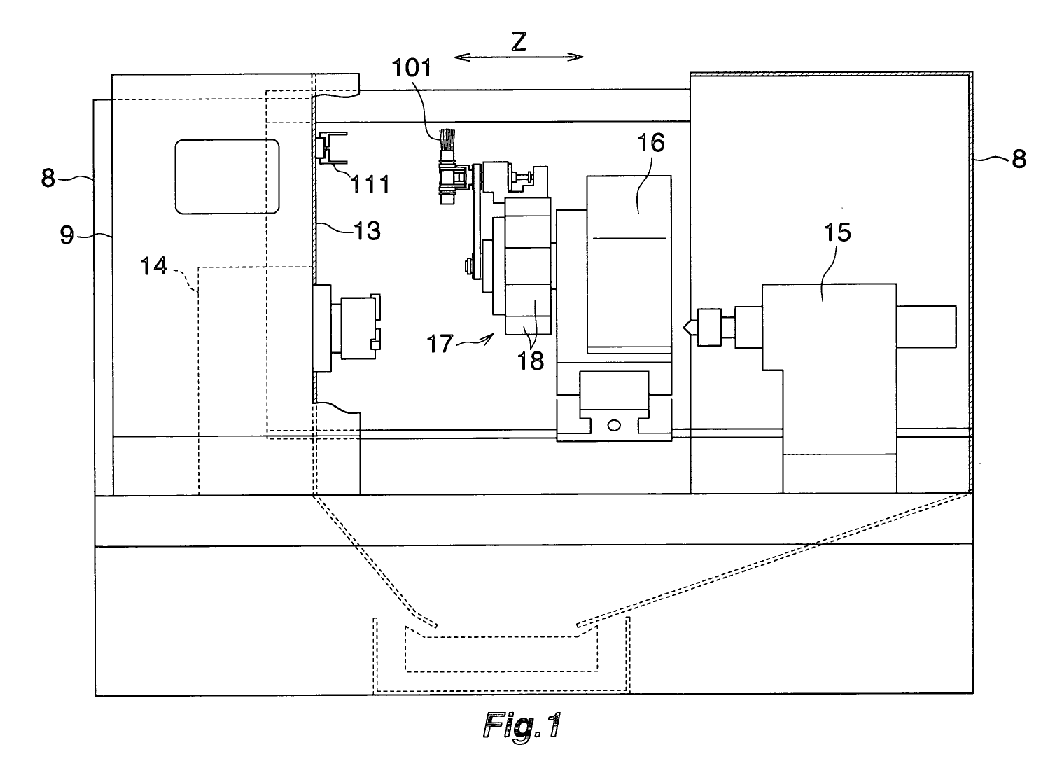

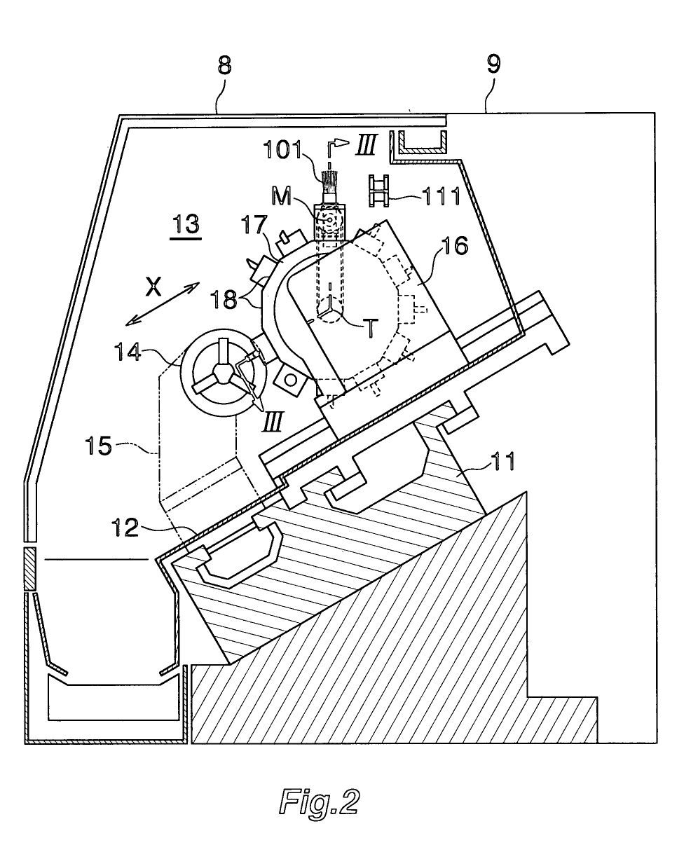

FIG. 1 and FIG. 2 illustrate the entire structure of an NC processing machine. In the following description, the forward and rearward directions (the direction of a Z axis) are defined such that the left side in FIG. 1 is the front side and the opposite side therefrom is the rear side, and the leftward and rightward directions are defined such that the left and right sides when viewed from the rear side will be refereed to as left and right sides (the left and right sides in FIG. 2).

A bed 11 is provided with a top surface which is inclined such that its right side is higher. The direction orthogonal to the direction of the Z axis along the inclination of the bed top surface is the direction of the X axis. In the space behind a partition cover 13, there is a processing chamber formed by a cover 12 covering the bed top surface and the portion at the right thereof, an entire cover 8, a door 9 covering the partially-cutout portion of the entire cover, and the partition cover 13.

A head stock 14 and a tail stock 15 are provided on the left-hand side of the bed top surface, such that they are faced to each other in the forward and rearward directions. The main shaft of the head stock 14 is penetrated at its tip end portion through the partition cover 13 and is intruded into the processing chamber. A tool post 16 is provided on the right-hand side of the bed top surface. The tool post 16 is movable in the direction of the Z axis and in the direction of the X axis, along the bed top surface. A turret 17 is supported on the rear surface of the tool post 16. The turret 17 is rotatable about a T axis which is parallel to the Z axis. There are provided a plurality of tool mounting surfaces 18 at the outer peripheral surface of the turret 17.

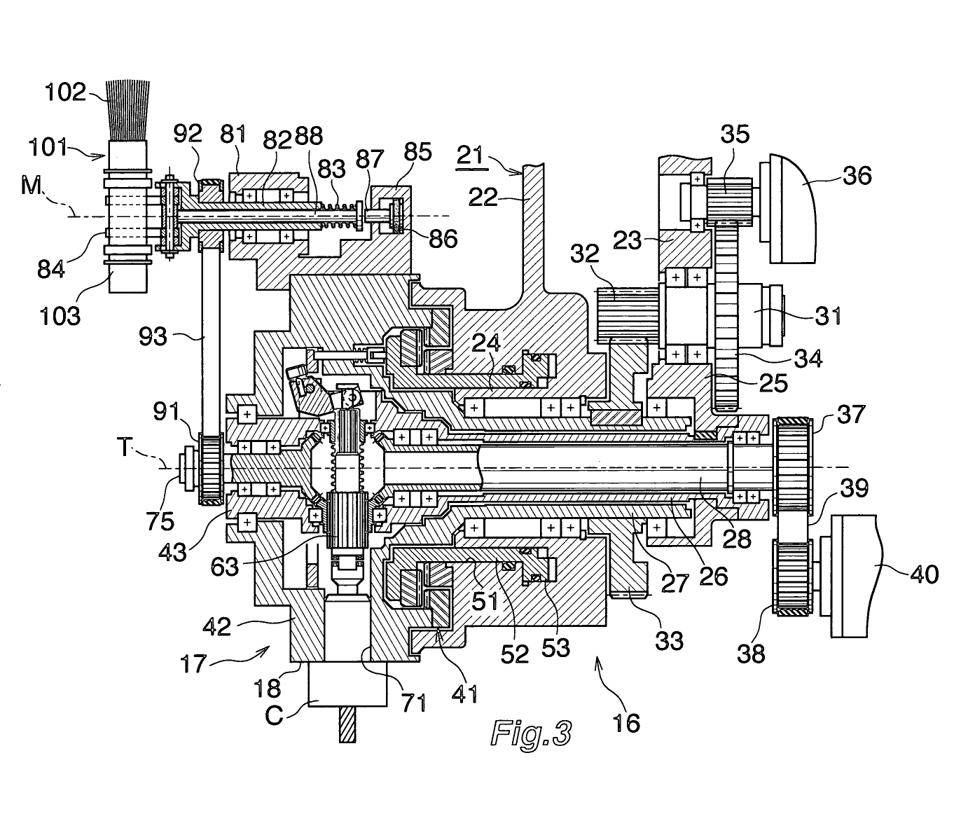

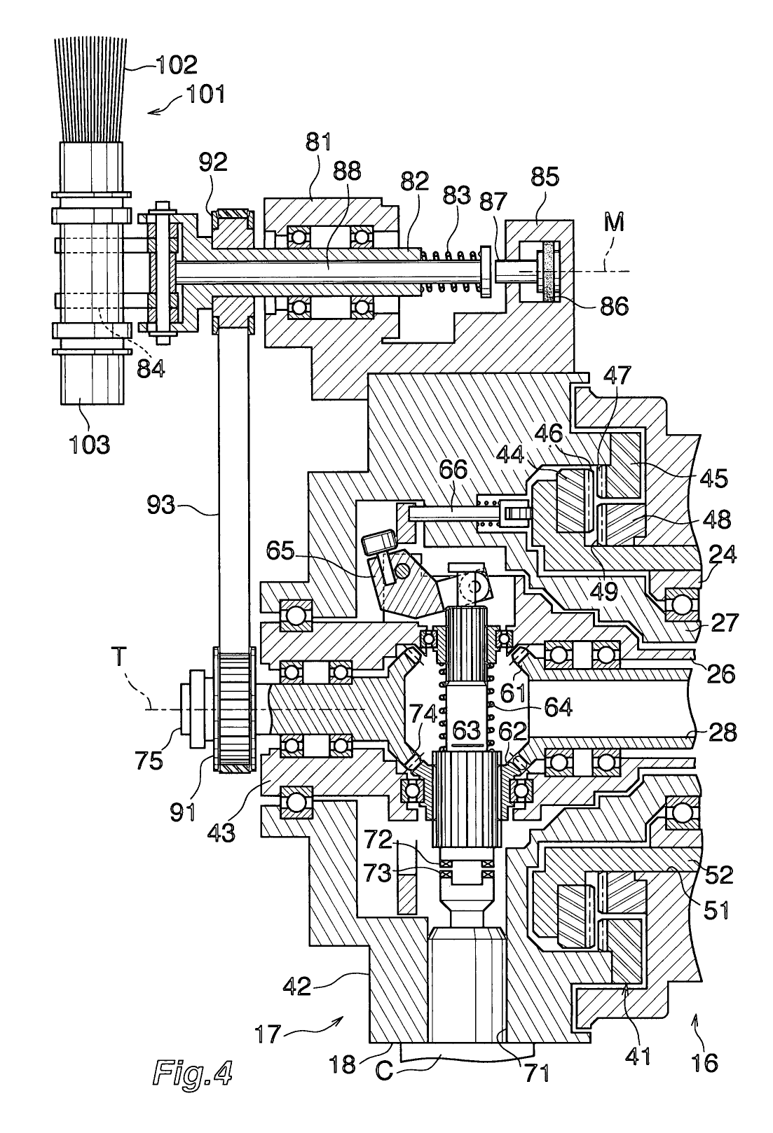

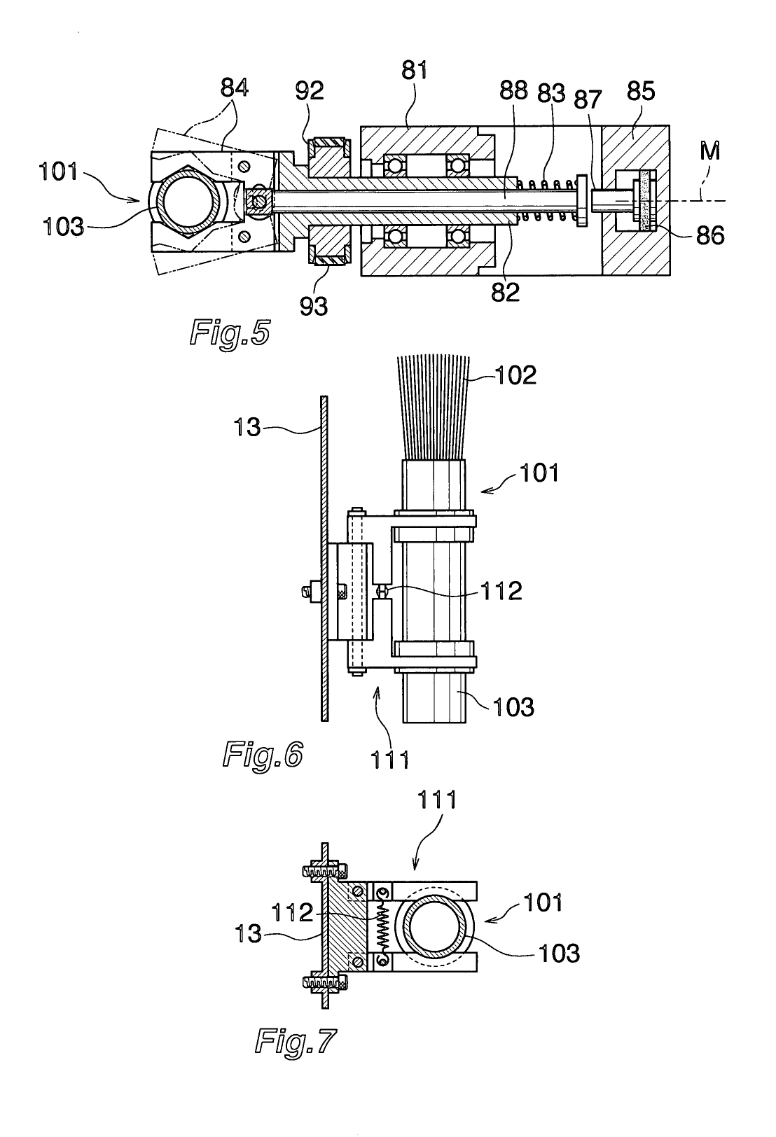

FIGS. 3 and 4 illustrate the tool post 16 and the turret 17 in detail.

The tool post 16 has a tool-post main body 21. The tool-post main body 21 has a front wall 22 and a rear wall 23. The front wall 22 is provided with a horizontal front holding tube 24, and the rear wall 23 is provided with a horizontal rear holding tube 25, concentrically. The front and rear holding tubes 24 and 25 are arranged with an interval therebetween in the forward and rearward directions. An internal holding tube 26 is inserted through the front and rear holding tubes 24 and 25 such that it is concentric with the front and rear holding tubes 24 and 25. The internal holding tube 26 is fixedly held at its rear end portion by the rear holding tube 25. A horizontal hollow-shaped revolution shaft 27 is extended among the front and rear holding tubes 24 and 25 and the internal holding tube 26. A hollow-shaft-shaped gear shaft 28 is extended along the center of the axis of the internal holding tube 26.

Above the rear holding tube 25, a horizontal transfer shaft 31 extending in the forward and rearward directions is penetrated through the rear wall 23 and held thereby. The transfer shaft 31 is provided with transfer teeth 32 at the front portion of its outer surface. The transfer teeth 32 are engaged with a driven gear 33. The driven gear 33 is positioned between the front and rear holding tubes 24 and 25 and is secured to the revolution shaft 27. A transfer gear 34 is secured to the rear potion of the outer surface of the transfer shaft 31. The transfer gear 34 is engaged with a driving gear 35. The driving gear 35 is secured to the output shaft of a revolution motor 36.

A driven pulley 37 is secured to the rear end portion of the gear shaft 28. The driven pulley 37 is coupled to a driving pulley 38 through a belt 39. The driving pulley 38 is secured to the output shaft of a rotation motor 40.

The turret 17 has a hollow-case-shaped turret main body 42. The turret main body 42 is coupled to the tool-post main body 21 through a coupling 41 and also is coupled to the front end of the revolution shaft 27 so that the turret main body 42 is rotatable about the T axis parallel to the Z axis. A housing 43 is housed within the turret main body 42. The housing 43 is coupled to the front end of the internal holding tube 26 such that its rotation is prevented and also is supported by the turret main body 42 such that the turret main body 42 is rotatable.

The coupling 41 is of a three-piece type and is constituted by a direct-acting coupling member 44, a rotational coupling member 45 and a stationary coupling member 48. All of these coupling members 44, 45 and 48 have a ring shape. The direct-acting coupling member 44 is faced to the rotational coupling member 45 and the stationary coupling member 48 in the forward and rearward directions, and the direct-acting coupling member 44, the rotational coupling member 45 and the stationary coupling member 48 are provided, at their surfaces faced to each other, with index teeth 46, 47 and 49 which can engage with one another at constant angular intervals.

The direct-acting coupling member 44 is secured to the front end portion of a tubular-shaped piston 52 which is fitted to the outer surface of the front holding tube 24 slidably in the forward and rearward directions, such that the direct-acting coupling member 44 is movable together with the piston 52 in the forward and rearward directions. The rotational coupling member 45 is secured to the rear end portion of the turret main body 42 such that the rotational coupling member 45 can be rotated together with the turret main body 42. The stationary coupling member 48 is secured to the tool-post main body 21.

The gear shaft 28 is provided, at its front end portion, with a driving bevel gear 61. The driving bevel gear 61 is engaged with a driven bevel gear 62. A vertical clutch shaft 63 is fitted within the driven bevel gear 62. The driven bevel gear 62 is coupled to the clutch shaft 63, in such a way as to constrain the rotation of the clutch shaft 63 while allowing it to move in the axial direction. The clutch shaft 63 is biased in the upward direction by a spring 64. A vertically-swayable lift arm 65 is contacted at its tip end portion with the upper end surface of the clutch shaft 63. A horizontal lift pin 66 is contacted at its front end portion with the base portion of the lift arm 65. The lift pin 66 is contacted at its rear end portion with the front surface of the direct-acting coupling member 44.

A tool C is mounted to a downward-facing tool mounting surface 18 of the turret main body 42. The turret main body 42 is provided with a mounting hole 71 into which the input shaft of the tool C which is oriented upward in the vertical direction is inserted. Engageable clutch portions 72 and 73 are provided at the lower end portion of the clutch shaft 63 and at the upper end portion of the input shaft, respectively.

At the side of the clutch shaft 63 which is opposite from the driving bevel gear 61, there is provided a transfer bevel gear 74 engaged with the driven bevel gear 62. The gear shaft 75 of the transfer bevel gear 74 is penetrated through the front wall of the housing 43 and is protruded forward therefrom.

A holder 81 is secured to an upward-facing tool mounting surface 18 of the turret main body 42. A horizontal gripper shaft 82 is rotatably supported by the holder 18. The gripper shaft 82 is rotatable about an M axis which is parallel to the T axis. At the front end portion of the gripper shaft 82, there is provided a movable gripper 84, such that the movable gripper 84 can be rotated together with the gripper shaft 82 and can be opened and closed. A draw shaft 88 is fitted within the gripper shaft 82 such that the draw shaft 88 is movable in the forward and rearward directions. The draw shaft 88 is coupled at its front end portion to one end portion of the movable gripper 84. The draw shaft 89 is biased in the rearward direction by a spring 83. A cylinder 85 is provided in the holder 81 such that it is positioned behind the draw shaft 89. A pusher 86 is housed within the cylinder 85 such that it is movable in the forward and rearward directions. The pusher 86 has a pusher pin 87 which is penetrated through the front wall 22 of the cylinder 85 and is faced to the rear end surface of the draw shaft 89 with an interval interposed therebetween.

A driving pulley 91 is secured to the gear shaft 75 of the transfer bevel gear 74. Corresponding thereto, a driven pulley 92 is secured to the gripper shaft 82. A belt 93 is wound around the driving pulley 91 and the driven pulley 92.

A cleaning tool 101 is held by the movable gripper 84. The cleaning tool 101 is constituted by a round-bar shaped handle 103 and a brush 102 implanted on one end portion of the handle 103.

FIGS. 3 and 4 illustrate a state where the rotational coupling member 45 is positioned at a limit of its forward movement and the direct-acting coupling member 44, the rotational coupling member 45 and the stationary coupling member 48 are at a coupling-OFF state. In this state, the turret main body 42 is rotatable with respect to the tool-post main body 21. In this state, when the revolution shaft 27 is rotated by driving the revolution motor 36, this will cause the turret main body 42 to rotate together with the revolution shaft 27.

On the other hand, the engageable clutch portions 72 and 73 are off the engagement therebetween. In this state, if the gear shaft 28 is rotated through the rotation motor 40, the clutch shaft 63 is rotated through the driven bevel gear 62, but the rotation thereof is not transferred to the input shaft of the tool T. The rotation of the driven bevel gear 62 is constantly transferred to the transfer bevel gear 74, and the rotation of the transfer bevel gear 74 is transferred to the gripper shaft 82 through the driving pulley 91, the driven pulley 92 and the belt 93. The gripper shaft 82 is rotated together with the cleaning tool 101.

When the piston 52 is backed off through fluid-pressure means which is not illustrated, the rotational coupling member 45 and the lift pin 66 are backed off together with the piston 52. Since the rotational coupling member 45 is backed off, the direct-acting coupling member 44, the rotational coupling member 45 and the stationary coupling member 48 are brought into a coupling-ON state. This constrains the rotation of the turret main body 42 with respect to the tool-post main body 21. Thus, positioning of the turret main body 42 at an index position is completed.

Since the lift pin 66 is backed off, the lift arm 65 loses the support therefor, and the clutch shaft 63 is moved downward by the force of the spring 64, thereby causing the engagement between the engageable clutch portions 72 and 73 to be ON. The rotation of the clutch shaft 63 is transferred to the input shaft of the tool T. This state is a normal processing state.

Further, when the pusher 86 is moved forward by causing fluid pressure to act on the cylinder 85 through the fluid-pressure means which is not illustrated, the pusher pin 87 pushes the draw shaft 89 forward, which causes the movable gripper 84 to open. If the supply of the fluid pressure is stopped, the draw shaft 89 is backed off by the spring 83, which causes the movable gripper 84 to close.

As illustrated in FIGS. 6 and 7, a stationary gripper 111 is provided on the partition cover 13. The stationary gripper 111 is biased by a spring 112 in such a direction that it is closed.

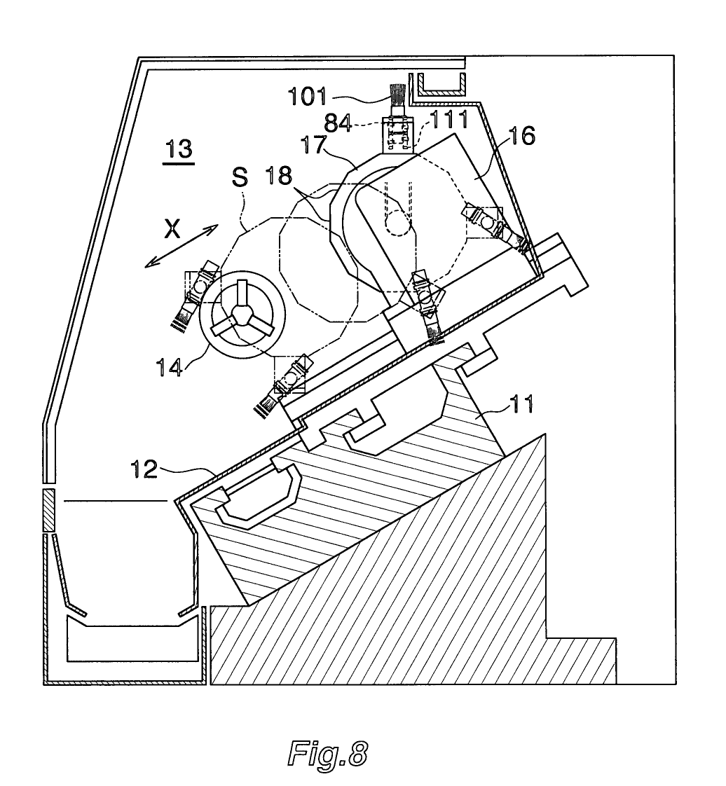

FIG. 8 illustrates a locus S of the tool post 16 and the turret 17 during an NC operation of the NC processing machine, namely a locus drawn by the tool post 16 and the turret 17 during the movement of the tool post 16 in the X direction and the rotation of the turret 17 about the T axis. As illustrated by a solid line in FIG. 8, the position of the stationary gripper 111 is set such that the movable gripper 84 and the stationary gripper 111 are aligned with each other when they are viewed in the forward and rearward directions, in a state where the tool post 16 is positioned at the right limit and the movable gripper 84 is positioned just thereabove. By moving the tool-post main body 21 in the Z direction and opening and closing the movable gripper 84 and the stationary gripper 111 in the state where the movable gripper 84 and the stationary gripper 111 are positioned as described above, it is possible to cause the movable gripper 84 and the stationary gripper 111 to transfer and receive the cleaning tool 101 to and from each other.

During normal processing operations, the cleaning tool 101 is gripped by the stationary gripper 111, as illustrated in FIGS. 6 and 7. In a cleaning operation, the rotation of the gripper shaft 82 is stopped. The movable gripper 84 is moved to the position at which the stationary gripper and the movable gripper 84 face each other, namely the position at which they are aligned with each other, and then the movable gripper 84 is moved forward toward the stationary gripper 111. At this time, the movable gripper 84 is kept opened. When the movable gripper 84 reaches a position at which the movable gripper 84 can grip the cleaning tool 101 gripped by the stationary gripper 111, the movement thereof is stopped, and then the movable gripper 84 is closed to grip the cleaning tool 101. In this state, if the movable gripper 84 is backed off, this will forcibly open the stationary gripper 111 which has gripped the cleaning tool 101, against the force of the spring 112. This causes the cleaning tool 101 to be transferred to the movable gripper 84 from the stationary gripper 111.

Then, the cleaning tool 101 is positioned at any position and further is moved, through the movement of the tool-post main body 21 in the direction of the X axis and the direction of the Z axis, the revolution of the turret main body 42 and the rotation of the gripper shaft 82, to clean away chips deposited on the upper portion of the head stock 14 and chips deposited on the cover 12, for example. This operation including mounting and dismounting of the cleaning tool 101 can be automatically performed by creating preliminarily programs therefor, in the same manner as for the processing operation.

After the completion of cleaning, the cleaning tool 101 can be transferred to the stationary gripper 111 from the movable gripper 84, through the reverse procedure from the aforementioned procedure.

Further, while, in the aforementioned embodiment, there has been exemplified an NC lathe structured such that the T axis is parallel to the Z axis, namely the turret is revolved in parallel with the Z axis, the T axis is not limited to an axis parallel to the Z axis, and the T axis can be properly changed as required and can be, for example, a rotation axis parallel to the X axis, a rotation axis in a plane including the X axis and the Z axis or an axis rotatable about an axis orthogonal to the X axis and the Z axis. Further, there has been exemplified a turret as a member having tool mounting surfaces, the component having tool mounting surfaces is not limited to a turret, but can be any member which can be revolved about the T axis with respect to the tool post. Further, a chip cleaning member can be preliminarily mounted on a tool mounting portion such as a turret.

What is claimed is:

1. A chip cleaning device in an NC processing machine comprising a tool post movable in the direction of a Z axis and in the direction of an X axis and a tool mounting portion supported on the tool post such that it is rotatable about a T axis, the chip cleaning device comprising a chip cleaning member supported on the tool mounting portion and being adapted to clean a chip within a processing chamber through composite operations of the movement of the tool post in the direction of the Z axis and in the direction of the X axis and the rotation of the tool mounting portion about the T axis.

2. A chip cleaning device comprising a rotational driving means for rotating a tool mounted on a tool mounting portion and being adapted to clean a chip within a processing chamber through composite operations of the movement of a tool post in the direction of a Z axis and in the direction of an X axis, the rotation of the tool mounting portion about a T axis, and the rotation of the tool.

3. The chip cleaning device according to claim 1, wherein the tool mounting portion is a turret having a plurality of tool mounting surfaces at its outer peripheral surface, and the chip cleaning device cleans a chip within the processing chamber through composite operations of the movement of the tool post in the direction of the Z axis and in the direction of the X axis and the rotation of the turret about the T axis.

4. The chip cleaning device according to claim 3, further comprising a driving means for rotating tools mounted to the tool mounting surfaces of the turret and being adapted to clean a chip within the processing chamber through composite operations of the movement of the tool post in the direction of the Z axis and in the direction of the X axis, the rotation of the tool mounting portions about the T axis and the rotation of the tools.

5. The chip cleaning device according to claim 4, further comprising: a gripper shaft supported on one of the tool mounting surfaces of the turret; a movable gripper capable of detachably gripping the chip cleaning member, the movable gripper being mounted to one end of the gripper shaft; and a stationary gripper capable of detachably gripping the chip cleaning member, the stationary gripper being placed such that it can transfer and receive the chip cleaning member to and from the movable gripper within the range of movement caused by composite operations of the movement of the tool post in the direction of the Z axis and in the direction of the X axis and the rotation of the turret about the T axis.

6. The chip cleaning device according to claim 5, wherein the gripper shaft is rotatably supported.
